(19) United States
(12) Patent Application Publication
(10) Pub. No.: US 2004/0106378 A1
(43) Pub. Date: Jun. 3, 2004

(54) Circuit connection restoration method and program for restoring connection in short time

(75) Inventors: Talguk Kim, Fukushima-ken (JP); Masaya Yamaguchi, Fukushima-ken (JP)

Correspondence Address: Brinks Hofer Gilson & Lione, P.O. Box 10395, Chicago, IL, 60610, US

(73) Assignee: Alps Electric Co. Ltd.

(21) Appl. No.: 10/719,518

(22) Filed: Nov. 21, 2003

(30) Foreign Application Priority Data
Nov. 29, 2002 (JP) 2002-347361

(51) Int. Cl. H04B 7/00; H04Q 7/20

(52) U.S. Cl. 455/41.2; 455/509

(57) ABSTRACT

An information communication apparatus includes a host computer and a BLUETOOTH module functioning as a communication module. A control unit of the BLUETOOTH module detects disconnection of a radio transmission link for a radio transmission signal and analyzes the reason for the disconnection. Then, the control unit determines whether or not to reconnect the disconnected radio transmission link on the basis of the analysis of the disconnection reason. If the disconnected radio transmission link should be reconnected, the control unit generates a reconnection command signal. In contrast, if the disconnected radio transmission link does not have to be reconnected, the control unit generates a forced link disconnection command signal.

This application claims the benefit of Japanese Patent Application 2002-347361, filed on Nov. 29, 2002, which is incorporated herein by reference.

### BACKGROUND OF THE INVENTION

1. Field of the Invention

The present invention relates to connection link restoration methods and connection link restoration programs, an information communication apparatus for performing the same, and more particularly, to a connection link restoration method and a connection link restoration program, and an information communication apparatus for a radio transmission link for radio communication between at least two information communication apparatuses.

2. Description of the Related Art

In recent years, radio communication systems, such as BLUETOOTH®, have been used as systems for transferring information between a plurality of information communication apparatuses, such as portable telephones, personal digital assistants (PDAs), portable personal computers, and printers.

Such information communication apparatuses comprise a host computer connected to a communication module, such as a BLUETOOTH module. The communication module of such an information communication apparatus converts information output from the host computer into a radio transmission signal and sends the radio transmission signal to another information communication apparatus. Also, the communication module converts a radio transmission signal received from the other information communication apparatus into a baseband signal and inputs the baseband signal to the host computer.

For example, the BLUETOOTH system, which is a radio communication system, uses a 2.4 GHz industrial scientific medical (ISM) band as a transmission frequency band, and has frequency channels with a bandwidth of 1 MHz. Also, a radio transmission signal is assigned, in accordance with a specified order, to one of the plurality of frequency channels by frequency hopping at regular time intervals. For the BLUETOOTH system, the electric field strength is very weak such that the effective transfer distance is assumed to be short, such as approximately 10 to 100 m.

Thus, the BLUETOOTH system is susceptible to other interference signals in the same transmission frequency band, and if a radio transmission signal is frequency-hopped to a frequency of an interference signal or a frequency channel near the frequency of an interference signal, an influence of the interference signal may prevent reception of the radio signal transmitted between the communication modules using the frequency channel, thus causing a communication failure.

In known information communication apparatuses, if the state of the communication failure continues for greater than a predetermined time, a BLUETOOTH module as a communication module automatically disconnects a radio transmission link, and outputs a disconnection event to the host computer representing disconnection of the link. Then, the host computer recognizes from the disconnection event the disconnection of the radio transmission link, and outputs a link connection command to the BLUETOOTH module for reconnection of the radio transmission link. The BLUETOOTH module then performs processing for reconnection of the radio transmission link in accordance with the connection link command. Accordingly, the information communication apparatus restores the radio transmission link that has been disconnected, so that the communication failure state can be resolved.

However, if the host computer in the information communication apparatus is performing processing for other information when the disconnection event is input to the host computer, the host computer first performs the processing for the other information and then outputs a connection link command to the BLUETOOTH module. Thus, if the disconnection event is input to the host computer when the host computer is performing other information processing, a long time is needed for the host computer to output the link connection command. As a result of this, there is a problem in that a long time is needed for the BLUETOOTH module to reconnect the disconnected radio transmission link in accordance with the link connection command sent from the host computer.

### SUMMARY OF THE INVENTION

Advantages of the present invention include mitigation of the problems described above. Embodiments of the present invention include a link connection restoration method and a link connection restoration program, and an information communication apparatus capable of quickly restoring connection of a radio transmission link that has been disconnected, irrespective of a state of a host computer in the information communication apparatus. The link connection is described herein with reference to a specific radio transmission link and link protocol, but it should be understood that this invention has application to a variety of data transmission links such as infra red and the internet and other radio communications protocols such as IEEE 802.11x, and the like.

In one aspect of the present invention, an information communication apparatus is provided, comprising a host computer, in communication with a communications module. The communications module may include a connection restoration unit, a baseband signal processing unit, radio transmission signal sending and receiving unit, and a control unit. A radio antenna may be integral to the communications module or separately provided and interfaced to the radio transmission unit thereof. The control unit has an interface with the host computer and with the aforementioned units of the communication module, such that data and control signals may be passed between the units and the host computer.

The information communication apparatus (the “first information communication apparatus”) may be in radio communication with another information communication apparatus (the “second information communication apparatus”) having the same configuration, or with another information communication apparatus having a different configuration, but being compatible with a common protocol for data exchange. When a disconnection of the radio link occurs, the disconnection of the radio transmission link is not reported to the host computer; analysis of the disconnection reason and determination of whether or not to reconnect the disconnected radio transmission link is performed by the communications module only. If the disconnected radio transmission link should be reconnected, processing for reconnection may be immediately and quickly performed by the communications module without waiting for the reconnection command signal sent from the host computer. Even if the host computer is performing other processing when the radio transmission link is disconnected, the disconnected radio transmission link can be immediately restored. Thus, the disconnected radio transmission link can be quickly reconnected.

The communications module may implement the BLUETOOTH communications protocol and specification, or be another radio communications method.

According to another aspect of the present invention, in a link connection restoration method, a control unit of a communications module in an information communication apparatus that includes a host computer and the communications module and that performs radio communication by transferring a radio transmission signal, detects disconnection of a radio transmission link for the radio transmission signal, analyzes the reason for the disconnection of the radio transmission link, determines whether or not to reconnect the disconnected radio transmission link on the basis of the analysis of the disconnection reason, generates a reconnection command signal if the disconnected radio transmission link should be reconnected, and generates a forced link disconnection command signal if the disconnected radio transmission link should not be reconnected.

According to the link connection restoration method, when the radio transmission link between the information communication apparatus and another information communication apparatus is disconnected, the disconnection of the radio transmission link is not reported to the host computer, and processing for reconnection of the radio transmission link may be performed only by the communication module. Even if the host computer is performing other processing when the radio transmission link is disconnected, the disconnected radio transmission link can be immediately reconnected by the communication module only without waiting for the reconnection command signal sent from the host computer. Thus, the disconnected radio transmission link can be quickly reconnected.

In the connection link restoration method, after determining that the disconnected radio transmission link should be reconnected, the control unit may determine whether or not the radio transmission link is connected from the information communication apparatus on the basis of the analyzed disconnection reason, generate the reconnection command signal if the radio transmission link is connected from the information communication apparatus, and wait for the reconnection command signal sent from another information communication apparatus if the radio transmission link is not connected from the information communication apparatus.

According to the connection link restoration method, when the radio transmission link is disconnected, the disconnection of the radio transmission link is not reported to the host computer. When the radio transmission link is connected from the information communication apparatus, processing for reconnection of the radio transmission link can be immediately and quickly performed by the communication module only without waiting for a reconnection command signal sent from the host computer.

In the connection link restoration method, the communication module may be a BLUETOOTH module. Also, the control unit may detect whether the reason for the disconnection of the radio transmission link arises from a plurality of upper protocol layers or from a lower protocol layer provided in the BLUETOOTH module.

According to the connection link restoration method, without regard to whether the reason for the disconnection of the radio transmission link arises from the upper protocol layers or the lower protocol layer, analysis of the disconnection reason and determination of whether or not to reconnect the disconnected radio transmission link is performed by the BLUETOOTH module only. If the disconnected radio transmission link should be reconnected, processing for reconnection can be immediately and quickly performed by the BLUETOOTH module without waiting for the reconnection command signal sent from the host computer.

According to still another an aspect of the present invention, a connection link restoration program causes a control unit of a communications module in the information communication apparatus, that includes a host computer and the communications module and that performs radio communication by transferring a radio transmission signal, to function as a detecting unit for detecting disconnection of a radio transmission link for the radio transmission signal, an analyzing unit for analyzing the reason for the disconnection of the radio transmission link, a reconnection determining unit for determining whether or not to reconnect the disconnected radio transmission link on the basis of the analysis of the disconnection reason, a reconnection command signal generating unit for generating a reconnection command signal if the disconnected radio transmission link should be reconnected, and a forced link disconnection command signal generating unit for generating a forced link disconnection command signal if the disconnected radio transmission link should not be reconnected.

According to the connection link restoration program, when the radio transmission link between the information communication apparatus and another information communication apparatus is disconnected, the disconnection of the radio transmission link is not reported to the host computer, and processing for reconnection of the radio transmission link may be performed by the communication module. Also, even if the host computer is performing other processing when the radio transmission link is disconnected, the disconnected radio transmission link can be immediately reconnected by the communication module only without waiting for the reconnection command signal sent from the host computer. Thus, the disconnected radio transmission link can be quickly reconnected.

The connection link restoration program may cause the control unit to function as a connecting apparatus determining unit for determining whether or not the radio transmission link is connected from the information communication apparatus on the basis of the analyzed disconnection reason after determining that the disconnected radio transmission link should be reconnected, the reconnection command signal generating unit for generating the reconnection command signal if the radio transmission link is connected from the information communication apparatus, and a waiting unit for waiting for the reconnection command signal sent from another information communication apparatus if the radio transmission link is not connected from the information communication apparatus.

According to the connection link restoration program, when the radio transmission link is disconnected, the disconnection of the radio transmission link is not reported to the host computer. When the radio transmission link is connected from the information communication apparatus, processing for reconnection of the radio transmission link can be immediately and quickly performed by the communication module only without waiting for the reconnection command signal sent from the host computer.

In the connection link restoration program, the communication module may be a BLUETOOTH module. The program may cause the control unit to function as a disconnection reason detecting unit for detecting whether the reason for the disconnection of the radio transmission link arises from a plurality of upper protocol layers or a lower protocol layer provided in the BLUETOOTH module.

According to the connection link restoration program, without regard to whether the reason for the disconnection of the radio transmission link arises from the upper protocol layers or from the lower protocol layer, analysis of the disconnection reason and determination of whether or not to reconnect the disconnected radio transmission link is performed by the BLUETOOTH module only. If the disconnected radio transmission link should be reconnected, processing for reconnection can be immediately and quickly performed by the BLUETOOTH module without waiting for the reconnection command signal sent from the host computer.

### BRIEF DESCRIPTION OF THE DRAWINGS

FIG. 1 is a block diagram of the structure of an information communication apparatus for executing a connection link restoration method according to an embodiment of the present invention;

FIG. 2 is a block diagram of the structure of a connection link restoration circuit of a communications module constituting the information communication apparatus shown in FIG. 1;

FIG. 3 is a block diagram of the relationship between a connection link restoration program according to a first embodiment of the present invention and protocol layers and an interface that are provided in a BLUETOOTH module functioning as a communications module;

FIG. 4 is a flowchart showing the sequence of processing of the connection link restoration method according to an embodiment of the present invention; and

FIG. 5 is a block diagram of the relationship between a connection link restoration program according to a second embodiment of the present invention and a protocol layer and an interface that are provided in a BLUETOOTH module functioning as a communication module.

### DESCRIPTION OF THE EMBODIMENTS

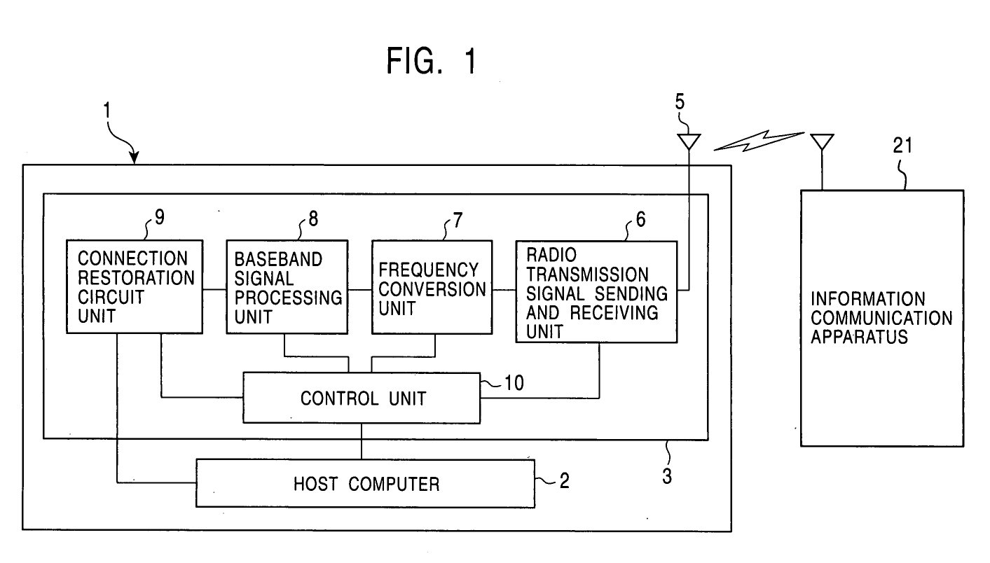

A connection link restoration method and a connection link restoration program according to the present invention will now be described with reference to FIGS. 1 to 5.

FIG. 1 shows an information communication apparatus 1 for executing a connection link restoration method and a connection link restoration program according to a first embodiment of the present invention. Referring to FIG. 1, the information communication apparatus 1 comprises a host computer 2 and a BLEUTOOTH module 3 functioning as a communications module.

In a first embodiment of the present invention, the BLUETOOTH module 3 comprises a radio transmission signal sending and receiving unit 6 connected to a sending and receiving antenna 5, a frequency conversion unit 7 connected to the radio transmission signal sending and receiving unit 6, a baseband signal processing unit 8 connected to the frequency conversion unit 7, and a connection restoration circuit unit 9 connected to the baseband signal processing unit 8. The connection restoration circuit unit 9 is also connected to the host computer 2. Also, the BLUETOOTH module 3 comprises a control unit 10 for controlling other units, such as the connection restoration circuit unit 9, of the BLUETOOTH module 3.

The BLUETOOTH module 3 may be provided with a lower protocol layer, such as a link manager protocol (LMP), a plurality of upper protocol layers (1, 2, . . . , n), such as an object exchange protocol (OBEX) and a serial port profile in addition to a logical link control and adaptation protocol (L2CAP) and a service discovery protocol (SDP), and an interface between the host and the module for transferring events and commands between an application program of the host computer 2 and the highest protocol layer of the upper protocol layers.

In the information communication apparatus 1, in order to send a radio transmission signal to another information communication apparatus 21, the control unit 10 of the BLUETOOTH module 3 causes the baseband signal processing unit 8 to convert a baseband signal, which is sent from the host computer 2 and received by the connection restoration circuit unit 9, into coded data and to send the coded data to the frequency conversion unit 7. Then, the control unit 10 causes the frequency conversion unit 7 to frequency-convert the coded data into a radio transmission signal and to send the radio transmission signal to the radio transmission signal sending and receiving unit 6. Then, the control unit 10 causes the radio transmission signal sending and receiving unit 6 to convert the radio transmission signal into a predetermined transmission levels and to send the converted radio transmission signal to another information communication apparatus 21 via the sending and receiving antenna 5.

Also, in the information communication apparatus 1, in order to receive a radio transmission signal from another information communication apparatus 21, the control unit 10 causes the radio transmission signal sending and receiving unit 6 to convert a radio transmission signal, which is sent from another information communication apparatus 21 and received by the sending and receiving antenna 5, into a predetermined reception level and to send the converted radio transmission signal to the frequency conversion unit 7. Then, the control unit 10 causes the frequency conversion unit 7 to frequency-convert the radio transmission signal into coded data and to send the coded data to the baseband signal processing unit 8. Then, the control unit 10 causes the baseband signal processing unit 8 to convert the coded data into a baseband signal and to send the baseband signal to the host computer 2 via the connection restoration circuit unit 9.

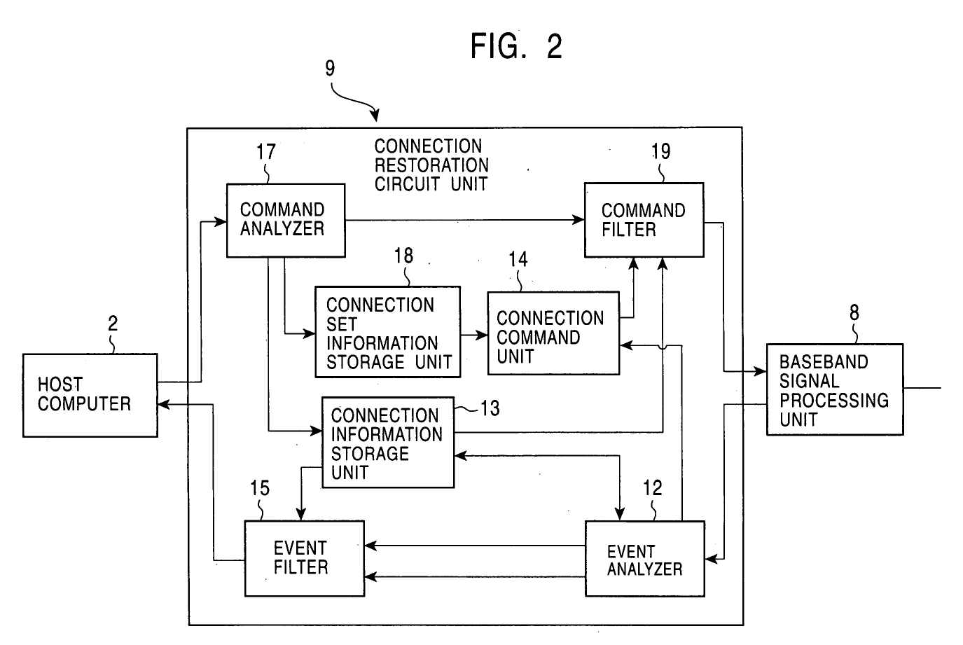

Referring to FIG. 2, the connection restoration circuit unit 9 comprises an event analyzer 12 connected to the baseband signal processing unit 8, a connection information storage unit 13 and a connection command unit 14 connected to the event analyzer 12, and an event filter 15 connected to the host computer 2 and the connection information storage unit 13. The connection restoration circuit unit 9 also comprises a command analyzer 17 connected to the host computer 2 and the connection information storage unit 13, a connection setup information storage unit 18 connected to the command analyzer 17 and the connection command unit 14, and a command filter 19 connected to the baseband signal processing unit 8, the connection information storage unit 13, the connection command unit 14, and the command analyzer 17.

When the radio transmission link becomes disconnected, the control unit 10 analyzes the reason for the disconnection and determines whether or not to reconnect the disconnected radio link. The control unit 10 generates a link disconnection signal to the communications restoration circuit 9, and causes the connection restoration circuit to check connection information which may be stored in the connection information storage unit 13, and the event analyzer 12 decides whether or not to reconnect the disconnected radio transmission link.

If the radio transmission link is connected from the information communications module 1, the control unit 10 causes the event analyzer 12 to send a drive control signal to the connection command unit 14 causing the connection command unit 14 to read connecting setup information stored in the connection setup storage unit 18. Also the control unit 10 sets the event filter 15 to a transmission prevention state preventing transmission of a link disconnection signal to the host computer 2.

The control unit 10 initiates a series of actions in accordance with the specific communications protocol chosen to effect reconnection of the radio transmission link between information communication apparatus 1 and another information communication apparatus 21. It is understood that the other information communication apparatus 21 may be a plurality of information communications apparatuses.

Alternatively, if the radio transmission link is connected from another information communications apparatus 21, the control unit 10 waits for the reconnection command signal sent from another information communication apparatus 21. In neither the situation where the radio transmission link is connected from the information communication apparatus 1 nor where the radio transmission link is connected from another information communication apparatus 21 is notification of the disconnected radio link signal sent to the host computer 2.

However, if it has been determined that the radio transmission link should not be re-established, a forced link disconnection signal is sent to the host computer 2 via an interface between the host computer 2 and the communications module 3.

Accordingly, performing the determination of whether the radio transmission link should be reconnected within the communications module permits the radio transmission link reestablishment process to proceed without delays due to the host computer 2 being busy performing other tasks.

Although the functional operation of individual units such as the control unit 12, connection restoration unit 9, and the like have been individually described, these functions may be performed by a shared electronic digital processor, such as a microprocessor and memory and peripheral circuitry rather than specific circuits for each function. Data as well as processor programs may be stored in such a shared memory. The memory may be a combination of various volatile and non-volatile memory circuits such as RAM, DRAM, EPROM and the like.

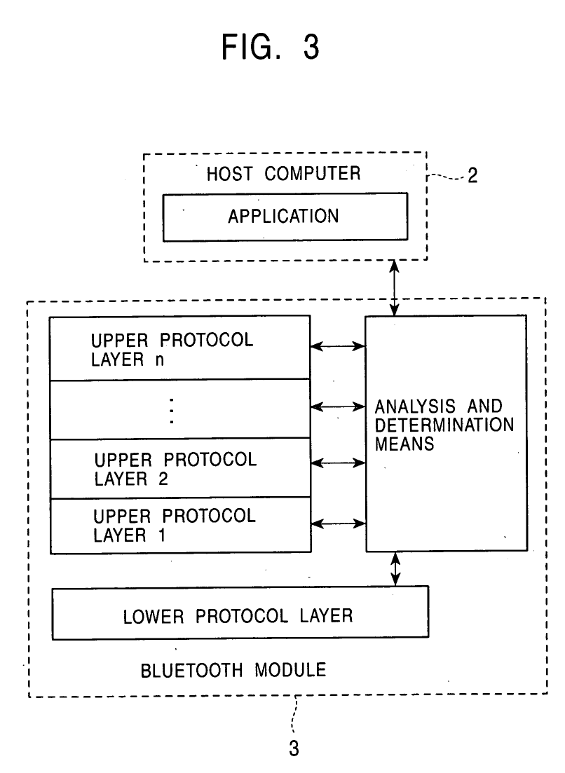

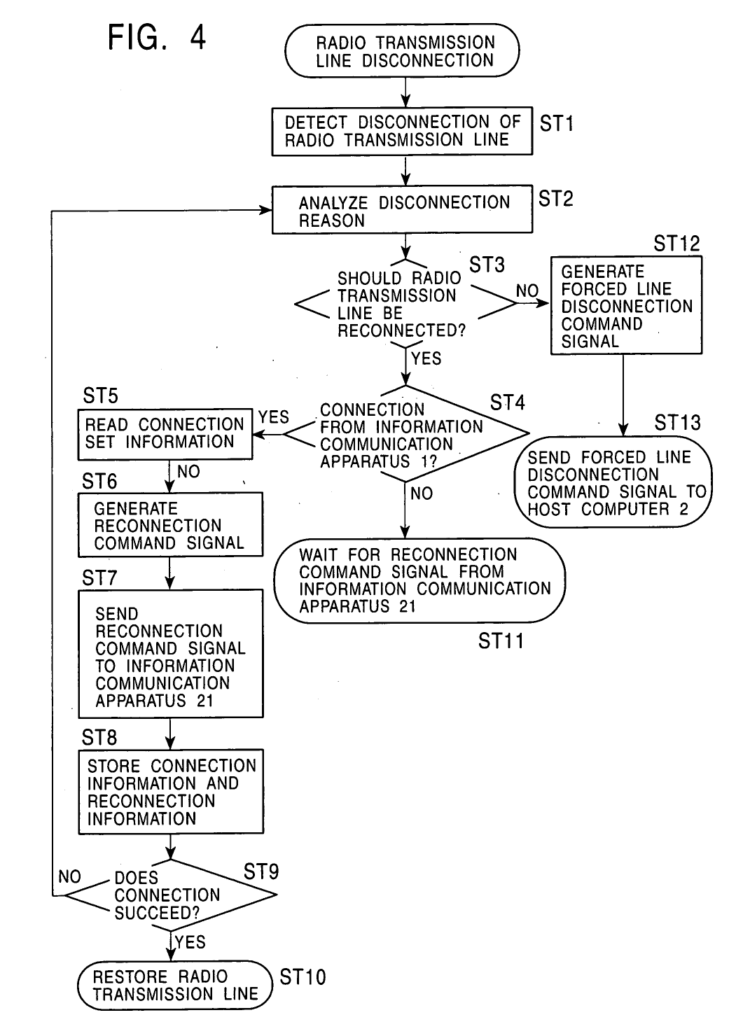

A connection link restoration method according to the first embodiment will now be described with reference to FIGS. 3 and 4.

FIG. 3 is a block diagram of the relationship between means for the connection link restoration program according to the first embodiment and the protocol layers and the interface that are provided in the BLUETOOTH module 3 functioning as a communications module. As shown in FIG. 3, the connection link restoration program causes the control unit 10 of the BLUETOOTH module 3 to function as analysis and determination means for analyzing the reason for disconnection of the radio transmission link and determining whether or not to reconnect the disconnected radio transmission link. The control unit 10, which functions as the analysis and determination means, is logically connected to the lower protocol layer, the upper protocol layers, and the interface between the host and the module.

Referring to FIG. 4, when the radio transmission link between the information communication apparatus 1 and another information communication apparatus 21 is disconnected due to a transmission failure state in a radio transmission signal or a normal state and when the reason for the disconnection of the radio transmission link arises from the lower protocol layer or the upper protocol layers, the control unit 10 of the BLUETOOTH module 3 detects the disconnection state of the radio transmission link (step ST1). Then, the control unit 10 causes the baseband signal processing unit 8 to generate a link disconnection signal and to send the link disconnection signal to the connection restoration circuit unit 9.

Then, the control unit 10 causes the event analyzer 12 of the connection restoration circuit unit 9 to check connection information, which represents a request for connection of the radio transmission link, stored in the connection information storage unit 13 of the connection restoration circuit unit 9 and to analyze the reason for the disconnection of the radio transmission link on the basis of the link disconnection signal (step ST2). The control unit 10 causes the event analyzer 12 of the connection restoration circuit unit 9 to determine whether or not to reconnect the disconnected radio transmission link (step ST3).

If it is determined that the disconnected radio transmission link should be reconnected (if the determination in step ST3 is YES), it is determined whether or not the radio transmission link is connected from the information communication apparatus 1 on the basis of the analyzed disconnection reason (step ST4). If the radio transmission link is connected from the information communication apparatus 1 (if the determination in step ST4 is YES), the control unit 10 causes the event analyzer 12 to send a drive control signal to the connection command unit 14 and causes the connection command unit 14 to read connection setup information, which represents the setting of connection of the radio transmission link, stored in the connection setup information storage unit 18 (step ST5) and to generate a reconnection command signal (step ST6). Also, the control unit 10 sets the event filter 15 of the connection restoration circuit unit 9 to a transmission prevention state, thus preventing transmission of the link disconnection signal to the host computer 2.

The control unit 10 causes the command filter 19 to send the reconnection command signal to the baseband signal processing unit 8, and then the reconnection command signal is sent to another information communication apparatus 21 via the frequency conversion unit 7, the radio transmission signal sending and receiving unit 6, and the sending and receiving antenna 5 (step ST7). After causing the baseband signal processing unit 8 to send an event to the connection restoration circuit unit 9, the control unit 10 causes the event analyzer 12 to extract the previous connection information and reconnection information, which represents reconnection, in accordance with the event and to store the connection information and the reconnection information into the connection information storage unit 13 (step ST8). Accordingly, the control unit 10 determines whether or not reconnection of the radio transmission link between the information communication apparatus 1 and another information communication apparatus 21 has succeeded (step ST9).

As a result of this, if the reconnection of the radio transmission link between the information communication apparatus 1 and another information communication apparatus 21 succeeds (if the determination in step ST9 is YES), connection of the radio transmission link is restored (step ST10). However, if the reconnection of the radio transmission link does not succeed (if the determination in step ST9 is NO), the control unit 10 analyzes the reason for the disconnection of the radio transmission link again (step ST2).

Then, the host computer 2 generates a command in accordance with the previous connection information and receives an event based on the connection information from the control unit 10 via the connection restoration circuit unit 9. Thus, the control unit 10 causes the event filter 15 to replace the reconnection information included in the event with the previous connection information and to send the event to the host computer 2. The control unit 10 also causes the command filter 19 to replace the reconnection information included in the command with the previous connection information.

If it is determined that the disconnected radio transmission link should be reconnected (if the determination in step ST3 is YES) and if it is determined that the radio transmission link is connected from another information communication apparatus 21 on the basis of the analyzed disconnection reason (if the determination in step ST4 is NO), the control unit 10 waits for the reconnection command signal sent from another information communication apparatus 21 (step ST11). Here, the control unit 10 sets the event filter 15 of the connection restoration circuit unit 9 to a transmission prevention state, thus preventing transmission of the connection link command signal to the host computer 2.

If it is determined that the disconnected radio transmission link should not be reconnected (the determination in step ST3 is NO), the control unit 10 causes the baseband signal processing unit 8 to generate a forced link disconnection command signal (step ST12), and causes the connection restoration circuit unit 9 to send the forced link disconnection command signal to the host computer 2 via the interface between the host and the module (step ST13). Here, the control unit 10 clears the connection information stored in the connection information storage unit 13 by a clear signal generated by the event analyzer 12 in response to the forced link disconnection command. The state in which the disconnected radio transmission link should not be reconnected is, for example, a case where the radio transmission link is disconnected in the normal state.

According to the first embodiment, when a radio transmission link between the information communication apparatus 1 and another information communication apparatus 21 is disconnected, the control unit 10 of the BLUETOOTH module 3 generates a link disconnection signal, analyzes the reason for the disconnection of the radio transmission link, and determines whether or not to reconnect the disconnected radio transmission link. If the disconnected radio transmission link should be reconnected, the control unit 10 generates a reconnection command signal and sends the reconnection command signal to the other information communication apparatus 21, so that the disconnected radio transmission link is reconnected. The link disconnection signal is not sent to the host computer 2. Thus, if the radio transmission link is disconnected due to a transmission failure, processing for reconnection of the radio transmission link can be performed by the BLUETOOTH module 3 only, not by the host computer 2 of the information communication apparatus 1.

Consequently, even if the host computer 2 is performing other processing when a radio transmission link is disconnected, the disconnected radio transmission link can be immediately reconnected by the BLUETOOTH module 3 only, without waiting for a reconnection command signal sent from the host computer 2. Thus, the disconnected radio transmission link can be rapidly reconnected.

Also, since the BLUETOOTH module 3 is provided with upper protocol layers as well as a lower protocol layer, without regard to whether the reason for disconnection of a radio transmission link arises from the lower protocol layer or the upper protocol layers, the control unit 10 analyzes the disconnection reason and determines whether or not to reconnect the disconnected radio transmission link. If the disconnected radio transmission link should be reconnected, the control unit 10 performs processing for reconnection. Thus, even if the reason for disconnection of a radio transmission link arises from the upper protocol layers, the disconnected radio transmission link can be immediately reconnected only by the BLUETOOTH module 3 without waiting for a reconnection command signal sent from the host computer 2.

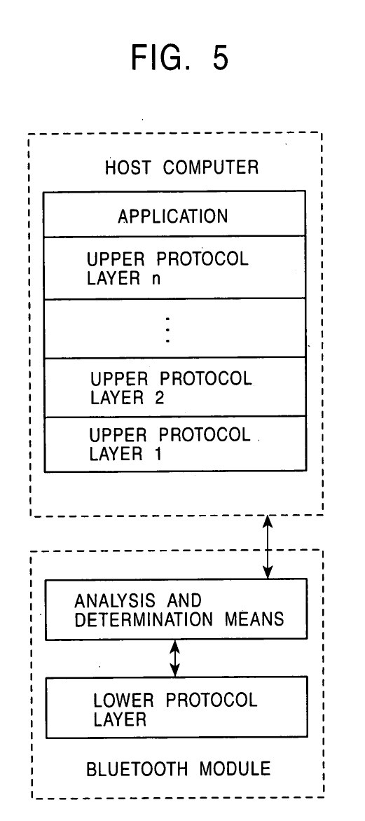

A second connection link restoration method and a connection link restoration program according to a second embodiment of the present invention will now be described with reference to FIG. 5. The apparatus is the same as described in conjunction with the first connection link restoration method and therefore will not be further described. Reference is made to FIGS. 1-3 and the description thereof previously given. The reference numerals used in the following description have the same meaning as for the first embodiment.

FIG. 5 is a block diagram of the relationship between the connection link restoration means according to the second embodiment and a protocol layer and an interface that are provided in a BLUETOOTH module functioning as a communication module.

As shown in FIG. 5, the BLUETOOTH module is provided with a lower protocol layer of BLUETOOTH and a host controller interface (HCI), and a host computer is provided with a plurality of upper protocol layers (1, 2, . . . , n) of BLUETOOTH.

The connection link restoration program causes a control unit of the BLUETOOTH module to function as an analysis and determination means for analyzing the reason for disconnection of a radio transmission link and determining whether or not to reconnect the disconnected radio transmission link. The control unit is connected to the lower protocol layer and the host computer 2 through an interface.

The method of the second embodiment will now be described.

When a radio transmission link between an information communication apparatus 1 and another information communication apparatus 21 is disconnected in a state of transmission failure in a radio transmission signal or a normal state and when the reason for the disconnection of the radio transmission link arises from the lower protocol layer, the control unit of the BLUETOOTH module detects the disconnection state of the radio transmission link. Then, the control unit causes a baseband signal processing unit 8 to generate a link disconnection signal and to send the link disconnection signal to a connection restoration circuit unit 9.

Then, the control unit 10 analyzes the reason for the disconnection of the radio transmission link on the basis of the link disconnection signal and determines whether or not to reconnect the disconnected radio transmission link. If it is determined that the disconnected radio transmission link should be reconnected and if the radio transmission link is connected from the information communication apparatus 1, the control unit performs reconnection of the radio transmission link between the information communication apparatus 1 and the another information communication apparatus 21 while causing the connection restoration circuit unit 9 to prevent transmission of the link disconnection signal to the host computer 2.

If it is determined that the disconnected radio transmission link should be reconnected and if the radio transmission link is connected from a BLUETOOTH module of another information communication apparatus 21, the control unit 10 waits for a reconnection command signal sent from the another information communication apparatus 21 while causing the connection restoration circuit unit 9 to prevent transmission of the link disconnection signal to the host computer 2.

If it is determined that the disconnected radio transmission link should not be reconnected, the control unit 9 generates a forced link disconnection command signal and sends the forced link disconnection signal to the host computer 2.

Since the other structure and operation of the second embodiment are similar to those in the first embodiment, the description for them is omitted here.

According to the second embodiment, when a radio transmission link between information communication apparatus 1 and another information communication apparatus 21 is disconnected and when the reason for the disconnection of the radio transmission link arises from the lower protocol layer, processing for reconnection of the radio transmission link can be performed by the BLUETOOTH module 3 only, not by the host computer 2.

Thus, even if the host computer 2 is performing other processing when the radio transmission link is disconnected, reconnection of the radio transmission link can be immediately and quickly performed by the BLUETOOTH module 3 only without waiting for a reconnection command signal sent from the host computer 2.

The present invention is not limited to the embodiments described above. Various changes and modifications may be made in the present invention without departing from the spirit and scope of the present invention.

Although, for example, the communication module is explained by way of example of a BLUETOOTH module, the communication module is not limited to this. Other types of data and radio communication modules may be used such as those defined by IEEE 802.11x and the like. Other communications media such as infra red and the internet are encompassed by this invention.

What is claimed is:

1. A connection link restoration method between a first information communication apparatus and a second information communication apparatus, the first information communication apparatus comprising a communications module and a host computer, the communications module performing the method which comprises:
communicating between the first information communication apparatus and the second information communication apparatus through a radio transmission link;
detecting a disconnection of the radio transmission link;
analyzing a reason for the disconnection of the radio transmission link;
determining whether or not to reconnect the disconnected radio transmission link on the basis of the analysis of the disconnection reason;
generating a reconnection command signal if the disconnected radio transmission link should be reconnected, and
generating a forced link disconnection command signal if the disconnected radio transmission link should not be reconnected.

2. The connection link restoration method according to claim 1, wherein after determining that the disconnected radio transmission link should be reconnected, a control unit of the communications module determines whether or not the radio transmission link is connected from the first information communication apparatus based on the analyzed reason for disconnection, generates the reconnection command signal if the radio transmission link is connected from the information communication apparatus, and waits for the reconnection command if the radio transmission link is not connected from the first information communication apparatus.

3. The connection link restoration method of claim 1, wherein the communication is performed between the first information communication apparatus and only one second information communication apparatus.

4. The connection link restoration method according to claim 1, wherein the communications module is a BLUETOOTH module, and wherein a control unit of the communications module determines whether the reason for the disconnection of the radio transmission link arises from a plurality of upper protocol layers or a lower protocol layer provided in the BLUETOOTH module.

5. A connection link restoration method for a first information communication apparatus, comprising:
providing a host computer;
providing a communications module in communication with the host computer, performing;
communicating data through a data transmission link;
detecting a disconnection of the data transmission link;
analyzing a reason for the disconnection of the data transmission link;
determining whether or not to reconnect the disconnected data transmission link on the basis of the analysis of the disconnection reason;
generating a reconnection command signal if the disconnected data transmission link should be reconnected; and
generating a forced link disconnection command signal if the disconnected data transmission link should not be reconnected.

6. The connection link restoration method according to claim 5, wherein after determining that the disconnected data transmission link should be reconnected, a control unit of the communications module determines whether or not the data transmission link is connected from the first information communication apparatus based on the analyzed reason for disconnection, generates the reconnection command signal if the data transmission link is connected from the first information communication apparatus, and waits for the reconnection command signal if the data transmission link is not connected from the first information communication apparatus.

7. The connection link restoration method of claim 5, wherein the communication is performed between the first information communication apparatus and only one second information communication apparatus.

8. The connection link restoration method of claim 5, wherein the communication is performed between the first information communication apparatus and a plurality of second information communication apparatus.

9. A connection link restoration method for a first information communication apparatus including a host computer and a communications module having a control unit, the communications module performing the method which comprises:
performing radio communication by transferring a radio transmission signal;
detecting disconnection of a radio transmission link for the radio transmission signal;
analyzing, in the control unit, a reason for the disconnection of the radio transmission link;
determining whether or not to reconnect the disconnected radio transmission link on the basis of the analysis of the disconnection reason;
generating a reconnection command signal if the disconnected radio transmission link should be reconnected; and,
generating a forced link disconnection command signal if the disconnected radio transmission link should not be reconnected.

10. A connection link restoration means, comprising:
means for performing radio communication;
means for detecting disconnection of a radio transmission link for a radio transmission signal, means for analyzing a reason for the disconnection of the radio transmission link,
means for determining whether or not to reconnect the disconnected radio transmission link on the basis of the analysis of the disconnection reason,
means for generating a reconnection command signal if the disconnected radio transmission link should be reconnected; and
means for generating a forced link disconnection command signal if the disconnected radio transmission link should not be reconnected.

11. The connection link restoration means according to claim 10, wherein the radio communication means comprises a first information communication apparatus and a second information communication apparatus, means for determining whether or not the radio transmission link is connected from the first information communication apparatus on the basis of the analysis of the disconnection reason, means for generating the reconnection command signal if the radio transmission link is connected from the first information communication apparatus, and means for waiting for the reconnection command signal if the radio transmission link is not connected from the first information communication apparatus.

12. The connection link restoration means according to claim 10, wherein the radio communication is performed between the first information communication apparatus and only one second information communication apparatus.

13. The connection link restoration program according to claim 10, wherein the radio communications means has a communications module, the communications module is a BLUETOOTH module, and wherein a control unit in the communications module comprises the means for determining whether the reason for the disconnection of the radio transmission link arises from a plurality of upper protocol layers or a lower protocol layer provided in the BLUETOOTH module.

14. A communications system, comprising:
a first information communication apparatus being in communication with a second information communication apparatus;
the first information communication apparatus having a host computer and a communications module interfaced with the host computer; and
the communications module having a control unit which determines a reason for a failure of communications between the first information communication apparatus and the second information communication apparatus,
wherein a link disconnection signal is not sent to the host computer when there is a failure of communications between the first information communication apparatus and the second information communication apparatus.

15. The communications system according to claim 14, wherein the control unit determines whether a reconnection command signal should be generated.

16. The communications system according to claim 15, wherein communications module further comprises a connection restoration circuit unit that reacts to the reconnection command signal by restoring a link connection between the first information communication apparatus and the second information communication apparatus if the link is connected from the first information communications apparatus, and waiting for a circuit reconnection signal from the second information communications apparatus if the link is connected from the second information communications apparatus.

17. The connection link restoration method of claim 14, wherein the communication is performed between the first information communication apparatus and only one second information communication apparatus.

18. The communications system according to claim 14, wherein the control unit determines that a communications link should not be reconnected and generates a forced link disconnection command.

19. The communications system according to claim 18, wherein the communications module comprises a connection restoration circuit unit, the forced link disconnection signal is sent to the host computer, and the reconnection command signal is sent to the connection restoration circuit unit.

20. A data communications system, comprising:
a first information communication apparatus having a host computer and a communications module, the communications module having a control unit and a connection restoration circuit unit; and
the information communication apparatus performing data communication through a data communications link;
the control unit analyzing whether or not to reconnect data communications link when the data communications link has been disconnected based on a disconnection reason and inhibits a link disconnection signal from being communicated to the host computer; and
the control unit generates a reconnection command signal if the data communications link should be reconnected and a forced link disconnection signal if the disconnected signal should not be reconnected.

21. The data communications system according to claim 20, wherein the forced link disconnection command signal is communicated to the host computer.

22. The data communications system according to claim 20, wherein when the control unit determines that the data communications link should be reconnected, the control unit analyzing whether the data communications link is connected from the first communications apparatus, and generates a reconnection command signal, and waits for the reconnection command signal if the data communications link is not connected from the first communications apparatus.
